(19) United States
(12) Patent Application Publication
(10) Pub. No.: US 2012/0112028 A1
(43) Pub. Date: May 10, 2012

(54) CUTTING PALLET

(75) Inventors: Katsumi Fujiwara, Hagagun (JP); Shunsuke Sunahara, Hagagun (JP); Takeshi Tada, Hagagun (JP); Takayuki Motojima, Hagagun (JP)

(73) Assignee: HONDA MOTOR CO., LTD., Tokyo (JP)

(21) Appl. No.: 13/285,335

(22) Filed: Oct. 31, 2011

(30) Foreign Application Priority Data
Nov. 5, 2010 (JP) 2010-248655

(51) Int. Cl. F16M 13/00

(52) U.S. Cl. 248/346.03

(57) ABSTRACT

A cutting pallet is provided that can prevent works held in a carrier device from interfering with a supply pallet, when a plurality of works arranged at even intervals is supplied at uneven intervals. The cutting pallet (6) in which a plurality of works (W) to be carried by the carrier device (1) is arranged is provided with a plurality of cutting pallet holes (61a, 61b, 62a, 62b, 63a, 63b, 64a and 64b) arranged at even intervals and to which a plurality of works W is inserted and removed, respectively. Among the plurality of cutting pallet holes (61a, 61b, 62a, 62b, 63a, 63b, 64a and 64b), the depths of holes adjacent to each of are different from each other.

This application is based on and claims the benefit of priority from Japanese Patent Application No. 2010-248655, filed on 5 Nov. 2010, the content of which is incorporated herein by reference.

### BACKGROUND OF THE INVENTION

1. Field of the Invention

The present invention relates to a cutting pallet. More specifically, the present invention relates to a cutting pallet on which a plurality of works to be taken out by a carrier device is arranged.

2. Related Art

Conventionally, in a manufacturing process, a plurality of works is temporarily stored in a cutting pallet for aligning these works at even intervals. A carrier device holds and carried the plurality of works arranged at even intervals in the cutting pallet, and supplies these works to a predetermined supply pallet.

Herein, when the plurality of works is arranged in the cutting pallet according to the type of work, the intervals have come to differ. Therefore, it has been necessary for the carrier device to change the positions of the retaining portions holding the plurality of works to the intervals of the works arranged in the cutting pallet.

Patent Document 1 discloses a tray on which a plurality of articles is arranged at even intervals at a predetermined pitch.

The plurality of articles arranged on this tray is maintained by an article supply device, and is supplied to a different tray in which the plurality of articles is arranged at even intervals at a different pitch from the predetermined pitch.

Patent Document 1: Japanese Unexamined Patent Application Publication No. 2005-67752

### SUMMARY OF THE INVENTION

However, a plurality of works arranged at even intervals on the cutting pallet may be supplied at uneven intervals in a manufacturing process. For example, in the manufacturing process of engines, the valve guides as works are arranged at even intervals on the cutting pallet, retained by a carrier device, carried to a supply pallet in which a plurality of holes for accommodating the valve guides is formed, and supplied into this plurality of holes. The holes of this supply pallet are formed to match the intervals of the exhaust ports and intake ports in the cylinder head of the engine, which is the finished product, and each is arranged on a substantially straight line; however, the intervals thereof are uneven intervals.

In such a case, the plurality of valve guides retained in the carrier device is supplied to the holes of supply pallet by dividing into more than one operation (dividing into a plurality of groups); however, when initially supplying a portion of the plurality of valve guides (first group) into the holes of the supply pallet, the valve guides not being supplied at this timing and remaining held in the carrier device (second group) may interfere with the supply pallet.

The present invention has an object of providing a cutting pallet that can prevent the works held in the carrier device from interfering with the supply pallet, when a plurality of works arranged at even intervals is supplied at uneven intervals.

According to a first aspect of the present invention, a cutting pallet (e.g., the cutting pallet 6 described later) in which a plurality of works (e.g., the works W described later) to be carried by a carrier device (e.g., the carrier device 1 described later) is arranged, includes:

A plurality of insertion/removal portions (e.g., the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b described later), arranged at even intervals, and to which the plurality of works is inserted and removed, respectively,

in which depths of insertion/removal portions adjacent to each other, among the plurality of insertion/removal portions, are different from each other.

According to the first aspect of the invention, the plurality of insertion/removal portions arranged at even intervals and to which the plurality of works is respectively inserted and removed is provided to the cutting pallet in which a plurality of works to be carried by the carrier device is arranged, and among this plurality of insertion/removal portions, the depths of the insertion/removal portions adjacent portions are established to be different from each other.

When the plurality of works is inserted into the plurality of insertion/removal portions arranged at even intervals, the adjacent works are thereby arranged in the cutting pallet at different heights from each other. When the plurality of works is retained in the carrier device in this state, they are retained in a state in which the lengths projecting from the carrier device differ from each other. Then, the plurality of works is carried by the carrier device to the supply pallet in which a plurality of holes to which the works are supplied is formed at uneven intervals, and in a case of works having a longer length of projecting from the carrier device among this plurality of works being supplied to the holes of the supply pallet, it is possible to prevent the other works from interfering with the supply pallet.

Therefore, a cutting pallet can be provided that can prevent the works held in the carrier device from interfering with the supply pallet, when a plurality of works arranged at even intervals is supplied at uneven intervals.

According to a second aspect of the invention, in the cutting pallet as described in the first aspect, the depths of the insertion/removal portions are alternately substantially the same among the plurality of insertion/removal portions.

According to the second aspect of the invention, the plurality of insertion/removal portions is established to have depths that are alternately substantially the same.

When the plurality of works is inserted into the plurality of insertion/removal portions arranged at even intervals, they are thereby arranged in the cutting pallet at alternately the same heights. When the plurality of works is held in the carrier device in this state, the lengths thereof protruding from the carrier device become alternately the same. Then, in a case in which the plurality of works are carried by way of the carrier device to the supply pallet in which the plurality of holes into which the works are supplied is formed at uneven intervals, and among this plurality of works, the works having a longer length protruding from the carrier device are supplied to the holes of the supply pallet, and then supplying the remaining works, it is possible to prevent the other works from interfering with the supply pallet.

For example, in the manufacturing process of engines, the holes of the supply pallet to which valve guides are supplied as the work are formed to match the intervals of the intake ports and exhaust ports in the cylinder head of the engine, which is the finished product, and thus these intake ports and exhaust ports are alternately formed at the same intervals. Consequently, in the manufacturing process of engines, that valve guides as the work are set alternately in one series, and valve guides are supplied in these series, whereby the working efficiency is improved.

Therefore, by establishing the plurality of insertion/removal portions to have depths that are alternately substantially the same, it is possible to provide a cutting pallet that can prevent works held in the carrier device from interfering with the supply pallet when a plurality of works arranged at even intervals are supplied at uneven intervals, which is preferable in order to align the valve guides that are works in the manufacturing process of engines.

According to the present invention, a cutting pallet can be provided that can prevent the works held in the carrier device from interfering with the supply pallet, when a plurality of works arranged at even intervals is supplied at uneven intervals.

### BRIEF DESCRIPTION OF THE DRAWINGS

FIG. 1 is a view showing a configuration of a carrier device 1 according to an embodiment of the present invention;

FIG. 2 is a view illustrating a cutting pallet and supply pallet according to the embodiment, with (a) being a cross-sectional view of the cutting pallet, and (b) being a cross-sectional view of the supply pallet;

FIG. 3 is a view illustrating an electrical configuration of a control unit according to the embodiment;

FIG. 4 is a view illustrating operation of the carrier device to hold a plurality of works arranged at even intervals in the cutting pallet, and carry to the supply pallet, with FIG. 4A being a view showing a state in which the carrier device is disposed above the plurality of works arranged at even intervals in the cutting pallet, FIG. 4B being a view showing a state in which the carrier device is holding the plurality of works, and FIG. 4C being a view showing a state in which the carrier device has carried the plurality of works to the supply pallet, and a portion of the plurality of works match predetermined positions on the supply pallet; and

FIG. 5 is a view illustrating operation of the carrier device to supply to the supply pallet the works carried to the supply pallet, with FIG. 5A being a view showing a state in which the carrier device has supplied a portion of the plurality of works to predetermined positions on the supply pallet, FIG. 5B being a view showing a state in which the carrier device has made a portion of the plurality of works match predetermined positions on the supply pallet, and FIG. 5C being a view showing a state in which the carrier device has supplied a portion of the plurality of works to predetermined positions on the supply pallet.

### DETAILED DESCRIPTION OF THE INVENTION

Hereinafter, embodiments of the present invention will be explained based on the appended drawings.

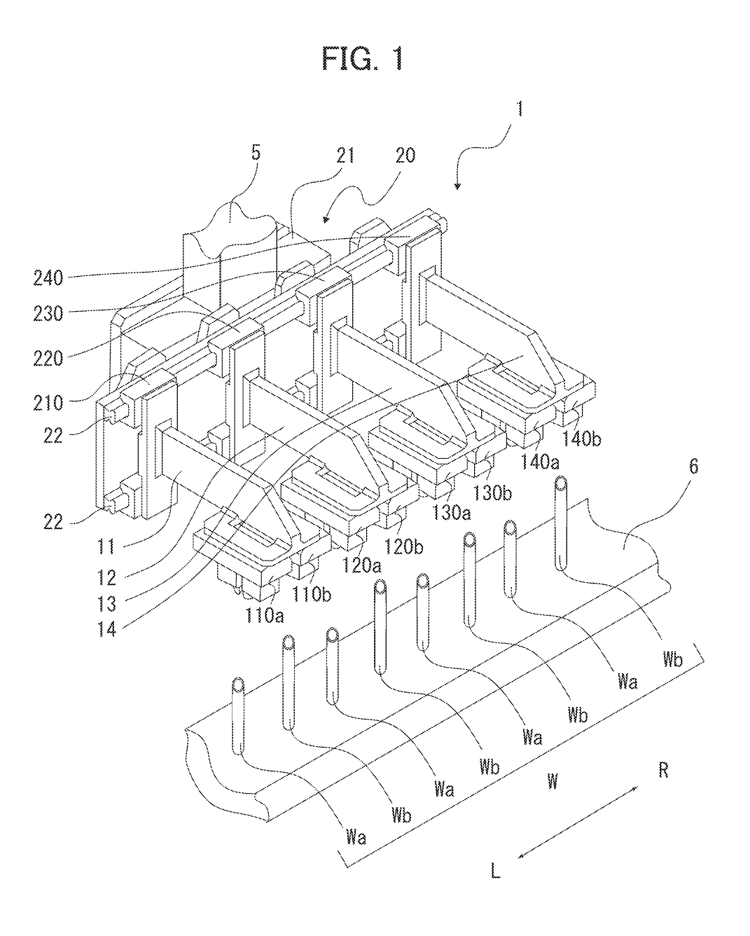

FIG. 1 is a view showing the configuration of a carrier device 1 according to one embodiment of the present invention.

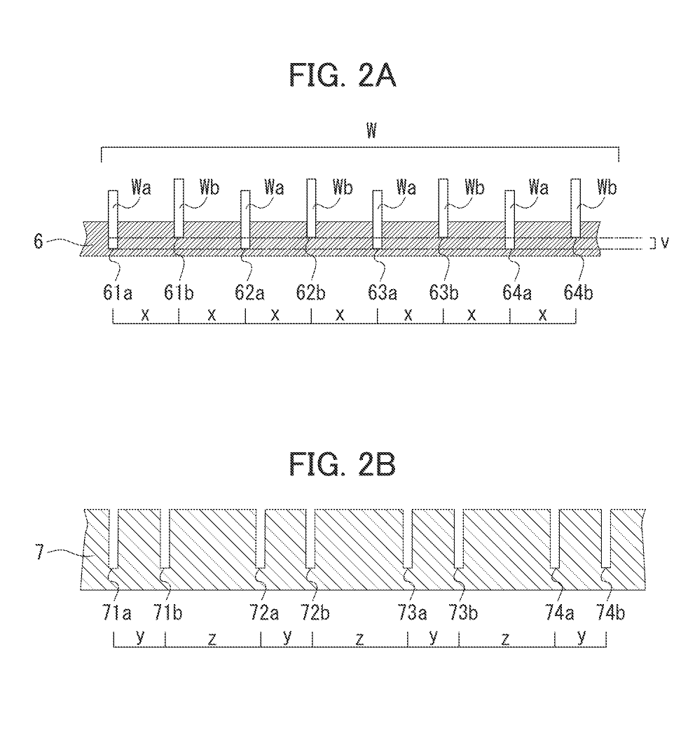

The carrier device 1 holds a plurality of works W arranged at even intervals in a cutting pallet 6, and supplies these works W to a supply pallet 7 (refer to FIG. 2) serving as a supply portion with uneven intervals, by being moved by a robot arm 5. In the present embodiment, the carrier device 1 is used in the manufacturing process of engines to hold and carry works W, which are valve guides, from the cutting pallet 6, and supply the works W to the supply pallet 7 (refer to FIG. 2).

The carrier device 1 is provided with a first retaining portion 11, second retaining portion 12, third retaining portion 13 and fourth retaining portion 14 that hold a plurality of the works W, and a retaining base portion 20 to which this first retaining portion 11, second retaining portion 12, third retaining portion 13 and fourth retaining portion 14 are connected.

The first retaining portion 11 is provided with a first engaging part 110a that disengages with a work Wa, and a second engaging part 110b that disengages with a work Wb. The first engaging part 110a and second engaging part 110b include a pair of chucks (not illustrated) that approach and separate relative to each other, and disengage with the work Wa and work Wb by causing each of this pair of chucks to operate to approach or separate from each other so as to “tighten” or “loosen”.

In the present embodiment, the work Wa and the work Wb are the same work W; however, in order to facilitate explanation, the work W disengaging with the first retaining portion will be referred to as the work Wa, and the work W disengaging with the second retaining portion will be referred to as the work Wb. Herein, the work Wa and the work Wb may be the same type of work, or may be different types of works from each other.

Similarly to the first retaining portion 11, the second retaining portion 12 is provided with a first engaging part 120a disengaging with the work Wa, and a second engaging part 120b disengaging with the work Wb; the third retaining portion 13 is provided with a first engaging part 130a disengaging with the work Wa, and a second engaging part 130b disengaging with the work Wb; and the fourth retaining portion 14 is provided with a first engaging part 140a disengaging with the work Wa, and a second engaging part 140b disengaging with the work Wb.

In the present embodiment, the four retaining portions of the first retaining portion 11, the second retaining portion 12, the third retaining portion 13 and the fourth retaining portion 14 are provided to the carrier device 1; however, it may be a different number of retaining portions. In addition, although two engaging parts 3 are provided to the first retaining portion 11, the second retaining portion 12, the third retaining portion 13 and the fourth retaining portion 14, respectively, in the present embodiment, it is not limited to two. Four engaging parts may be provided to each retaining portion. Four of the works could thereby be held, carried and supplied to the supply portion by one retaining portion.

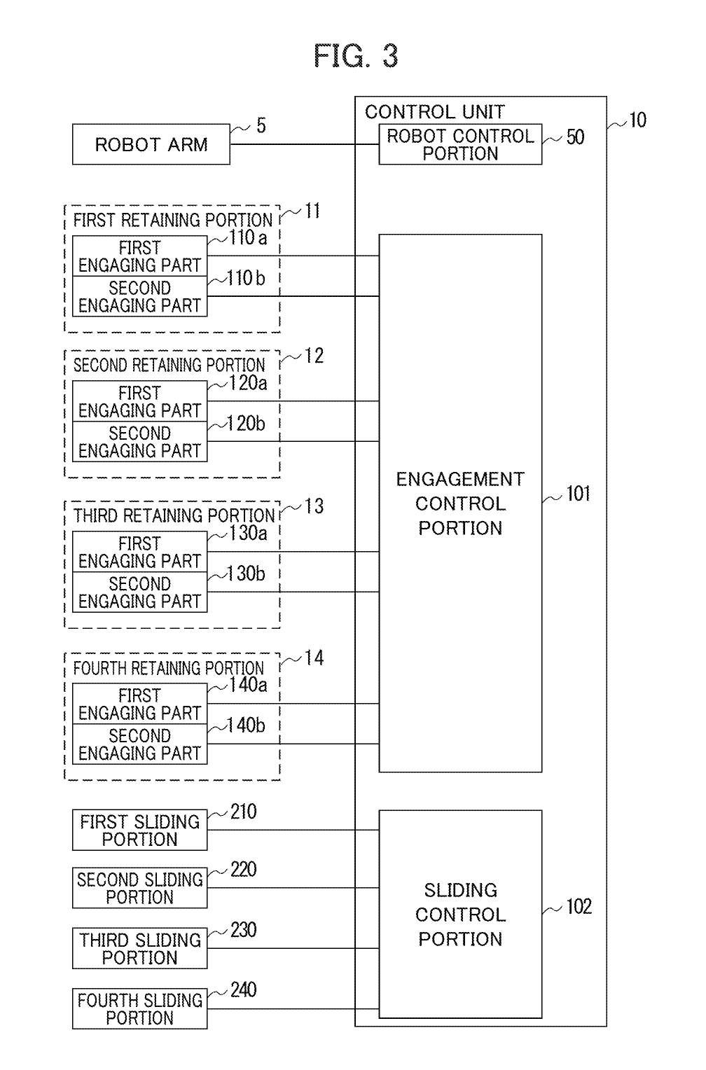

The first engaging part 110a and the second engaging part 110b are each independently controlled by a control unit 10 (refer to FIG. 3). In other words, the first engaging part 110a disengages with the work Wa and the second engaging part 110b disengages with the work Wb at independent timings.

Similarly, the first engaging part 120a and the second engaging part 120b are each independently controlled by the control unit 10 (refer to FIG. 3). In other words, the first engaging part 120a disengages with the work Wa and the second engaging part 120b disengages with the work Wb at independent timings.

In addition, the first engaging part 130a and the second engaging part 130b are each independently controlled by the control unit 10 (refer to FIG. 3) in a similar way. In other words, the first engaging part 130a disengages with the work Wa and the second engaging part 130b disengages with the work Wb at independent timings.

Furthermore, the first engaging part 140a and the second engaging part 140b are each independently controlled by the control unit 10 (refer to FIG. 3) in a similar way. In other words, the first engaging part 140a disengages with the work Wa and the second engaging part 140b disengages with the work Wb at independent timings.

The retaining base portion 20 is provided with a retaining-base portion main body 21 that is connected to the robot arm 5; two rail portions 22 provided to the retaining-base portion main body 21 and extending in a direction (LR direction in FIG. 1) in which the works W are arranged in the cutting pallet 6; and first sliding portions 210, second sliding portions 220, third sliding portions 230 and fourth sliding portions 240 that engage with the rail portions 22 to be slidable.

The first sliding portions 210 are connected by the first retaining portion 11, and move in the L direction or R direction along the rail portions 22, according to the control of the control unit 10 (refer to FIG. 3). The first retaining portion 11 thereby moves in the arrangement direction (LR direction in FIG. 1) of the works W accompanying the movement of the first sliding portions 210.

The second sliding portions 220 are connected by the second retaining portion 12, and move this second retaining portion 12 in the L direction or R direction along the rail portions 22, according to the control of the control unit 10 (refer to FIG. 3). The second retaining portion 12 thereby moves in the arrangement direction (LR direction in FIG. 1) of the works W accompanying the movement of the second sliding portions 220.

The third sliding portions 230 are connected by the third retaining portion 13, and move this third retaining portion 13 in the L direction or R direction along the rail portions 22, according to the control of the control unit 10 (refer to FIG. 3). The third retaining portion 13 thereby moves in the arrangement direction (LR direction in FIG. 1) of the works W accompanying the movement of the third sliding portions 230.

The fourth sliding portions 240 are connected by the fourth retaining portion 14, and move this fourth retaining portion 14 in the L direction or R direction along the rail portions 22, according to the control of the control unit 10 (refer to FIG. 3). The fourth retaining portion 14 thereby moves in the arrangement direction (LR direction in FIG. 1) of the works W accompanying the movement of the fourth sliding portions 240.

In this way, the first sliding portions 210, second sliding portions 220, third sliding portions 230 and fourth sliding portions 240 cause the first retaining portion 11, second retaining portion 12, third retaining portion 13 and fourth retaining portion 14 to approach or separate from each other in the arrangement direction (LR direction in FIG. 1) of the works W.

The first sliding portions 210, second sliding portions 220, third sliding portions 230 and fourth sliding portions 240 are each provided with a motor (not illustrated) that is controlled by the control unit 10 (refer to FIG. 3) and a cam (not illustrated) that rotates according to this motor, and each moves in the L direction or R direction along the rail portions 22 to a predetermined position according to the rotation of this cam.

FIG. 2 is a view illustrating the cutting pallet 6 and the supply pallet 7 according to the present embodiment. FIG. 2A is a cross-sectional view of the cutting pallet 6. FIG. 2B is a cross-sectional view of the supply pallet 7.

As a plurality of insertion/removal portions, the cutting pallet 6 is provided with a cutting pallet hole 61a in which the work Wa engaging with the first engaging part 110a (refer to FIG. 1) is inserted and removed, a cutting pallet hole 61b in which the work Wb engaging with the second engaging part 110b (refer to FIG. 1) is inserted and removed, a cutting pallet hole 62a in which the work Wa engaging with the first engaging part 120a (refer to FIG. 1) is inserted and removed, a cutting pallet hole 62b in which the work Wb engaging with the second engaging part 120b (refer to FIG. 1) is inserted and removed, a cutting pallet hole 63a in which the work Wa engaging with the first engaging part 130a (refer to FIG. 1) is inserted and removed, a cutting pallet hole 63b in which the work Wb engaging with the second engaging part 130b (refer to FIG. 1) is inserted and removed, a cutting pallet hole 64a in which the work Wa engaging with the first engaging part 140a (refer to FIG. 1) is inserted and removed, and a cutting pallet hole 64b in which the work Wb engaging with the second engaging part 140b (refer to FIG. 1) is inserted and removed.

The cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b are formed at even intervals with a predetermined interval x (e.g., 40 mm).

The cutting pallet hole 61b, cutting pallet 62b, cutting pallet 63b and cutting pallet 64b are formed to have a depth that is shallow at a length v from the top surface of the cutting pallet 6, compared to the cutting pallet hole 61a, cutting pallet hole 62a, cutting pallet hole 63a and cutting pallet hole 64a adjacent to these. In other words, for the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b, the depths of adjacent holes are different from each other; however, the depths are alternately substantially the same. When the work Wa and work Wb arranged in the cutting pallet 6 are held by the carrier device 1 (refer to FIG. 1), the length of the work Wa protruding from the carrier device 1 is longer than that of the work Wb by the length v, whereby it is possible to prevent the work Wb and the supply pallet 7 from interfering when supplying the work Wa to the supply pallet 7.

The supply pallet 7 is provided with a supply pallet hole 71a to which the work Wa engaged with the first engaging part 110a (refer to FIG. 1) is supplied, a supply pallet hole 71b to which the work Wb engaged with the second engaging part 110b (refer to FIG. 1) is supplied, a supply pallet hole 72a to which the work Wa engaged with the first engaging part 120a (refer to FIG. 1) is supplied, a supply pallet hole 72b to which the work Wb engaged with the second engaging part 120b (refer to FIG. 1) is supplied, a supply pallet hole 73a to which the work Wa engaged with the first engaging part 130a (refer to FIG. 1) is supplied, a supply pallet hole 73b to which the work Wb engaged with the second engaging part 130b (refer to FIG. 1) is supplied, a supply pallet hole 74a to which the work Wa engaged with the first engaging part 140a (refer to FIG. 1) is supplied, and a supply pallet hole 74b to which the work Wb engaged with the second engaging part 140b (refer to FIG. 1) is supplied.

The supply pallet hole 71a and supply pallet hole 71b; supply pallet hole 72a and supply pallet hole 72b; supply pallet hole 73a and supply pallet hole 73b; and supply pallet hole 74a and supply pallet hole 74b are formed to be respectively spaced by an interval y (e.g., 35 mm). In addition, the supply pallet hole 71b and supply pallet hole 72a; supply pallet hole 72b and supply pallet hole 73a; and supply pallet hole 73b and supply pallet hole 74a are formed to be respectively spaced by an interval z (e.g., 50 mm). In this way, the supply pallet hole 71a, supply pallet hole 71b, supply pallet hole 72a, supply hole 72b, supply pallet hole 73a, supply pallet hole 73b, supply pallet hole 74a and supply pallet hole 74b to which the works W (work Wa and work Wb) are supplied are formed at uneven intervals in the supply pallet 7. It should be noted that the intervals of the holes in the supply pallet 7 are not limited to the two of the interval y and the interval z. For example, any intervals can be established, such as all of the intervals differing.

In the present embodiment, the supply pallet hole 71a, supply pallet hole 71b, supply pallet hole 72a, supply hole 72b, supply pallet hole 73a, supply pallet hole 73b, supply pallet hole 74a and supply pallet hole 74b to which the works W (work Wa and work Wb), which are valve guides, are supplied are formed at the same intervals as the intervals of the intake ports and exhaust ports formed in the cylinder head of an engine, which is the finished product of manufacturing. In other words, the intervals y and z are decided according to the intervals of the intake ports and exhaust ports formed in the cylinder head of the engine that is the finished product.

Next, the electrical configuration of the control unit 10 will be explained while referring to FIG. 3.

FIG. 3 is a view illustrating the electrical configuration of the control unit 10 according to the present embodiment.

The control unit 10 is provided with a robot control portion 50 that controls the movement of the robot arm 5; an engagement control portion 101 that independently controls the first retaining portion 11, second retaining portion 12, third retaining portion 13 and fourth retaining portion 14; and a sliding control portion 102 that independently controls the first sliding portions 210, second sliding portions 220, third sliding portions 230 and fourth sliding portions 240.

The engagement control portion 101 is independently connected to the first engaging part 110a and second engaging part 110b of the first retaining portion 11, the first engaging part 120a and second engaging part 120b of the second retaining portion 12, the first engaging part 130a and second engaging part 130b of the third retaining portion 13, and the first engaging part 140a and second engaging part 140b of the fourth retaining portion 14, respectively, and controls the operation to cause the works W (refer to FIG. 1) to be disengaged at independent timings, respectively.

The sliding control portion 102 is independently connected to the first sliding portions 210, second sliding portions 220, third sliding portions 230 and fourth sliding portions 240, respectively, and controls the movements of independent predetermined distances, respectively.

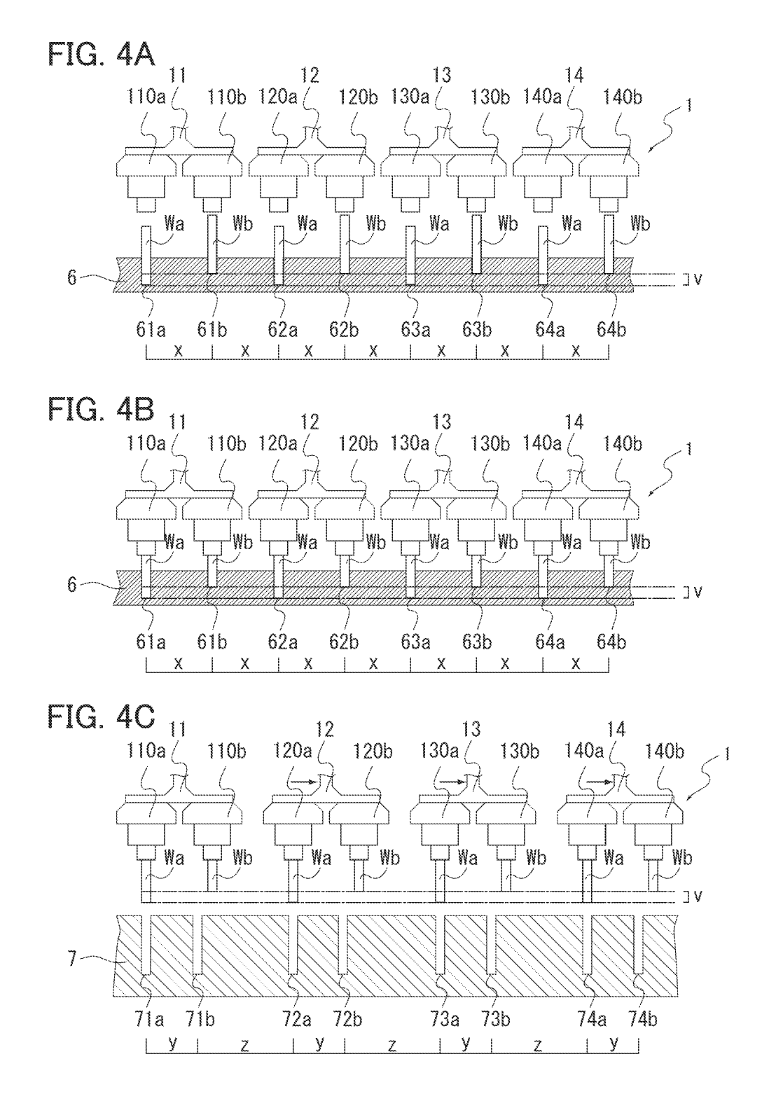

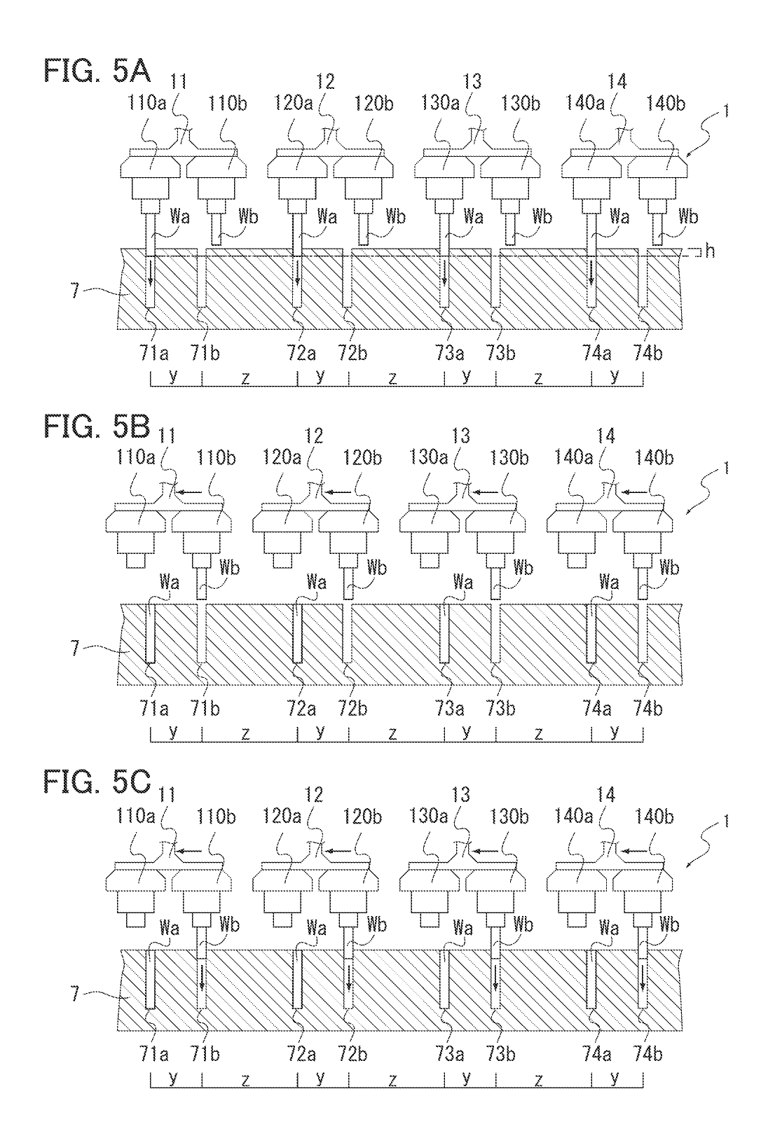

Next, operation of the carrier device 1 will be explained while referring to FIGS. 4 and 5.

FIG. 4 is a view illustrating operations of the carrier device 1 to hold the plurality of works Wa and Wb arranged at even intervals on the cutting pallet 6, and to carry these to the supply pallet 7. FIG. 4A is a view showing a state in which the carrier device 1 is disposed above the plurality of works Wa and Wb arranged at even intervals in the cutting pallet 6. FIG. 4B is a view showing a state in which the carrier device 1 is holding the plurality of works Wa and Wb. FIG. 4C is a view showing a state in which the carrier device 1 has carried the plurality of works Wa and Wb to the supply pallet 7, and the plurality of works Wa match predetermined positions on the supply pallet 7.

FIG. 5 is a view illustrating operations of the carrier device 1 to supply to the supply pallet 7 the works Wa and Wb carried to the supply pallet. FIG. 5A is a view showing a state in which the carrier device 1 has supplied the plurality of works Wa to predetermined positions on the supply pallet 7. FIG. 5B is a view showing a state in which the carrier device 1 has made the plurality of works Wb match predetermined positions on the supply pallet 7. FIG. 5C is a view showing a state in which the carrier device 1 has supplied the plurality of works Wb to predetermined positions on the supply pallet 7.

First, as shown in FIG. 4A, the carrier device 1 is disposed, by way of the robot arm 5 (refer to FIG. 1), above the works Wa and works Wb inserted in the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b formed at even intervals x (e.g., 40 mm) from each other in the cutting pallet 6. At this time, the first engaging part 110a and second engaging part 110b of the first retaining portion 11, the first engaging part 120a and second engaging part 120b of the second retaining portion 12, the first engaging part 130a and second engaging part 130b of the third retaining portion 13, the first engaging part 140a and second engaging part 140b of the fourth retaining portion 14 are disposed at even intervals x from each other, similarly to the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b.

In addition, the cutting pallet hole 61b, cutting pallet hole 62b, cutting pallet hole 63b and cutting pallet hole 64b are formed to have a depth from the top surface of the cutting pallet 6 that is shallow at a length v, compared to the cutting pallet hole 61a, cutting pallet hole 62a, cutting pallet hole 63a and cutting pallet hole 64a adjacent to these.

Next, as shown in FIG. 4B, the carrier device 1 is brought closer to the plurality of works Wa and Wb disposed in the cutting pallet 6 by the robot arm 5 (refer to FIG. 1), and holds the plurality of works Wa and Wb at the same height, according to the control of the engagement control portion 101 (refer to FIG. 3). More specifically, the first engaging part 110a engages with the work Wa inserted in the cutting pallet hole 61a. The first engaging part 120a engages with the work Wa inserted in the cutting pallet hole 62a. The first engaging part 130a engages with the work Wa inserted in the cutting pallet hole 63a. The first engaging part 140a engages with the work Wa inserted in the cutting pallet hole 64a. In addition, the second engaging part 110b engages with the work Wb inserted in the cutting pallet hole 61b. The second engaging part 120b engages with the work Wb inserted in the cutting pallet hole 62b. The second engaging part 130b engages with the work Wb inserted in the cutting pallet hole 63b. The second engaging part 140b engages with the work Wb inserted in the cutting pallet hole 64b. The works Wa held by the carrier device 1 thereby have a length protruding from the carrier device 1 that is longer than the works Wb by the length v.

Next, as shown in FIG. 4C, the carrier device 1 carries the plurality of works Wa and Wb thus held to the supply pallet 7 by way of the robot arm 5 (refer to FIG. 1). At this time, according to the control of the sliding control portion 102 (refer to FIG. 3), the carrier device 1 disposes the work Wa engaged with the first engaging part 110a above the supply pallet hole 71a of the supply pallet 7, disposes the work Wa engaged with the first engaging part 120a above the supply pallet hole 72a of the supply pallet 7, disposes the work Wa engaged with the first engaging part 130a above the supply pallet hole 73a of the supply pallet 7, and disposes the work Wa engaged with the first engaging part 140a above the supply pallet hole 74a of the supply pallet 7.

Next, as shown in FIG. 5A, the carrier device 1 is brought close to the supply pallet 7 by way of the robot arm 5 (refer to FIG. 1). The leading end of the work Wa engaged with the first engaging part 110a is thereby inserted into the supply pallet hole 71a by the length h. The leading end of the work Wa engaged with the first engaging part 120a is thereby inserted into the supply pallet hole 72a by the length h. The leading end of the work Wa engaged with the first engaging part 130a is thereby inserted into the supply pallet hole 73a by the length h. The leading end of the work Wa engaged with the first engaging part 140a is thereby inserted into the supply pallet hole 74a by the length h. Herein, the length h is a value smaller than the length v (refer to FIG. 4C), which is the difference in length by which the work Wa protrudes from the carrier device 1 compared to the work Wb. Therefore, the works Wb engaged to the second engaging part 110b, second engaging part 120b, second engaging part 130b and second engaging part 140b do not interfere with the supply pallet 7.

Thereafter, according to the control of the engagement control portion 101 (refer to FIG. 3), the carrier device 1 releases the engagement with the works Wa of the first engaging part 110a, first engaging part 120a, first engaging part 130a and first engaging part 140a. The works Wa engaged with the first engaging part 110a, first engaging part 120a, first engaging part 130a and first engaging part 140a thereby drop down to be supplied to the supply pallet hole 71a, supply pallet hole 72a, supply pallet hole 73a and supply pallet hole 74a, respectively.

In this way, with the works Wa engaged with the first engaging part 110a, first engaging part 120a, first engaging part 130a and first engaging part 140a set to arbitrary intervals (y+z), and these works Wa defined as a first group, the carrier device 1 supplies the works Wa of this first group to the supply pallet 7 all at once, according to the control of the sliding control portion 102 (refer to FIG. 3).

Next, as shown in FIG. 5B, according to the control of the sliding control portion 102 (refer to FIG. 3), the carrier device 1 disposes the work Wb engaged with the second engaging part 110b above the supply pallet hole 71b of the supply pallet 7, disposes the work Wb engaged with the second engaging part 120b above the supply pallet hole 72b of the supply pallet 7, disposes the work Wb engaged with the second engaging part 130b above the supply pallet hole 73b of the supply pallet 7, and disposes the work Wb engaged with the second engaging part 140b above the supply pallet hole 74b of the supply pallet 7.

Next, as shown in FIG. 5C, the carrier device 1 is brought close to the supply pallet 7 by way of the robot arm 5 (refer to FIG. 1). The leading end portion of the work Wb engaged with the second engaging part 110b is thereby inserted in the supply pallet hole 71b. The leading end portion of the work Wb engaged with the second engaging part 120b is thereby inserted in the supply pallet hole 72b. The leading end portion of the work Wb engaged with the second engaging part 130b is thereby inserted in the supply pallet hole 73b. The leading end portion of the work Wb engaged with the second engaging part 140b is thereby inserted in the supply pallet hole 74b.

Thereafter, according to the control of the engagement control portion 101 (refer to FIG. 3), the carrier device 1 releases the engagement with the works Wb of the second engaging part 110b, second engaging part 120b, second engaging part 130b and second engaging part 140b. The works Wb engaged with the second engaging part 110b, second engaging part 120b, second engaging part 130b and second engaging part 140b thereby drop down to be supplied to the supply pallet hole 71b, supply pallet hole 72b, supply pallet hole 73b and supply pallet hole 74b, respectively.

In this way, with the works Wb engaged with the second engaging part 110b, second engaging part 120b, second engaging part 130b and second engaging part 140b set to arbitrary intervals (z+y), and these works Wb defined as a second group, the carrier device 1 supplies the works Wb of this second group to the supply pallet 7 all at once, according to the control of the sliding control portion 102 (refer to FIG. 3).

The following functional effects are exerted according to the present embodiment.

The cutting pallet 6 of the present embodiment has a plurality of works W to be carried by the carrier device 1 arranged therein, and is provided with the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b arranged at even intervals in which the plurality of works W is respectively inserted and removed. The cutting pallet hole 61b, cutting pallet hole 62b, cutting pallet hole 63b and cutting pallet hole 64b are formed to have a depth from the top surface of the cutting pallet 6 that is shallow at the length v, compared to the cutting pallet hole 61a, cutting pallet hole 62a, cutting pallet hole 63a and cutting pallet hole 64a adjacent to these.

The plurality of works W is thereby arranged in the cutting pallet 6 at different heights from each other when inserted into the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b arranged at even intervals. When the plurality of works W is held in the carrier device 1 in this state, they are retained in a state in which the lengths protruding from the carrier device 1 differ from each other. Then, in a case in which the plurality of works W are carried by way of the carrier device 1 to the supply pallet 7 in which the supply pallet hole 71a, supply pallet hole 71b, supply pallet hole 72a, supply pallet hole 72b, supply pallet hole 73a, supply pallet hole 73b, supply pallet hole 74a and supply pallet hole 74b are formed at uneven intervals, and among this plurality of works W, the works Wa having a longer length protruding from the carrier device 1 are supplied to the supply pallet hole 71a, supply pallet hole 72a, supply pallet hole 73a and supply pallet hole 74a, it is possible to prevent the works Wb from interfering with the supply pallet 7.

Therefore, a cutting pallet can be provided that can prevent the works held in the carrier device from interfering with the supply pallet, when a plurality of works arranged at even intervals is supplied at uneven intervals.

In addition, the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b are established to have depths that are alternately substantially the same.

When the plurality of works W is inserted into the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b arranged at even intervals, they are arranged in the cutting pallet 6 at alternately the same heights. When the plurality of works W is held in the carrier device 1 in this state, the lengths thereof protruding from the carrier device 1 become alternately the same. Then, in a case in which the plurality of works W are carried by way of the carrier device 1 to the supply pallet 7 in which the supply pallet hole 71a, supply pallet hole 71b, supply pallet hole 72a, supply pallet hole 72b, supply pallet hole 73a, supply pallet hole 73b, supply pallet hole 74a and supply pallet hole 74b are formed at uneven intervals, and among this plurality of works W, the works Wa having a longer length protruding from the carrier device 1 being supplied to the holes of the supply pallet 7, and then supplying the remaining works Wb, it is possible to prevent the works Wb from interfering with the supply pallet 7.

For example, in the manufacturing process of engines, the holes of the supply pallet to which valve guides are supplied as the work are formed to match the intervals of the intake ports and exhaust ports in the cylinder head of the engine, which is the finished product, and thus these intake ports and exhaust ports are alternately formed at the same intervals. Consequently, in the manufacturing process of engines, the valve guides as the work are set alternately in one series (first group of the works Wa and second group of the works Wb), and valve guides are supplied to the supply pallet 7 in these series, whereby the working efficiency is improved.

Therefore, by establishing the cutting pallet hole 61a, cutting pallet hole 61b, cutting pallet hole 62a, cutting pallet hole 62b, cutting pallet hole 63a, cutting pallet hole 63b, cutting pallet hole 64a and cutting pallet hole 64b to have depths that are alternately substantially the same, it is possible to provide a cutting pallet that can prevent works held in the carrier device from interfering with the supply pallet when a plurality of works arranged at even intervals are supplied at uneven intervals, which is preferable in order to align the valve guides that are works in the manufacturing process of engines.

It should be noted that the present invention is not to be limited to the above embodiment, and that modifications, improvements and the like within a scope that can achieve the object of the present invention are included in the present invention.

What is claimed is:

1. A cutting pallet in which a plurality of works to be carried by a carrier device is arranged, the cutting pallet comprising:
a plurality of insertion/removal portions arranged at even intervals, and to which the plurality of works is inserted and removed, respectively,
wherein depths of insertion/removal portions adjacent to each other, among the plurality of insertion/removal portions, are different from each other.

2. A cutting pallet according to claim 1,
wherein the depths of the insertion/removal portions are alternately substantially the same among the plurality of insertion/removal portions.
